(19) United States
(12) Patent Application Publication
(10) Pub. No.: US 2004/0083207 A1
(43) Pub. Date: Apr. 29, 2004

(54) Multiple option search technology

(76) Inventors: David J. Jeffries II, Raleigh, NC (US); Bryan K. Pack, Raleigh, NC (US)

Correspondence Address: David J. Jeffries II, 8260-104 Hempshire Place, Raleigh, NC, 27613, US

(21) Appl. No.: 10/390,116

(22) Filed: Mar. 17, 2003

Related U.S. Application Data
(60) Provisional application No. 60/365,276, filed on Mar. 18, 2002.

(51) Int. Cl. G06F 17/30

(52) U.S. Cl. 707/3

(57) ABSTRACT

A system whereby an individual can search on the Internet and contact multiple service providers simultaneously via e-mail using a fully integratable search and contact accessible from multiple party company websites and can receive e-mail responses from service providers displayed that can meet said site visitor's needs. The partnering companies can custom the search unction to fit seamlessly on their websites trough the creation of new search-specific pages on their websites, either dynamically generated from XML data or by the use of HTML framesets. The data displayed on these pages is contained on the host company server, so all data maintenance is handled by the host company ad not the pair. The system allows partner companies to customize the e-mail leads sent to service providers by customer searches conducted from their websites and to contact site visitors directly using an auto-response e-mail feature.

### CROSS-REFERENCE TO RELATED APPLICATIONS

Not Applicable.

### BACKGROUND

1. Field of Invention

This invention relates to a means whereby an individual can search on the internet and contact multiple service providers all at once, through a fully integratable format on multiple partnering websites, and have them respond according to their ability to meet the individual's service needs.

2. Description of Prior Art

Travel Groups and Search Engine providers commonly supply their website visitors with the function of searching out certain options or information when considering a service provider which can best meet their needs.

Originally these search functions were provided from one participating website that could only be accessed directly by typing in the exact URL (web address) or by utilizing a link to another website, that when clicked directed a person to the search website.

Thereafter, inventors created several types of search interfaces that provided website visitors better access to their databases of information through partnering websites. Such search engines as Google and Northern Light allow searches to be conducted from partnering websites; however, these searches do not keep the site visitor on the website from which the search is being conducted, but instead direct that customer to the Google or Northern Light website. Additionally, there is not necessarily a correlation between the website on which the search access is being housed and the type of search that can be conducted by a customer on that website. Priceline.com is another type of service company that provides a more direct, time saving search through its website by allowing a customer to input their service desire parameters and then farming those parameters out to a specified list of subscribing service providers within their database. If one or more of those service providers “meets” the request of the customer, a contract is thereby created between the requesting customer and the subscribing service provider.

Although Priceline.com does provide for multiple service providers to be contacted, it does not have multiple points of access from participating partner websites through which a customer who visits those other sites can utilize Priceline.com's functionality. When a customer does use their functionality and a service provider initiates a positive response to the parameters that were provided by that customer, a contract is automatically created and enforced. A customer cannot explore options and cannot back out of the contract after the service provider meets his terms. Although the search engines such as Google and Northern Light do provide points of access from participating partnering websites, they are limited and do not provide a full integration with that partnering website. The interface does not appear as though the customer is utilizing a feature of that partnering website and the search engine points of access do not seek to keep the customer on the partnering website, but instead direct the customer to their URL. They also do not provide for the automatic contacting of multiple service providers that may be able to fulfill the desires of the inquiring customer.

### SUMMARY

In accordance with the present invention a means whereby a customer can search and contact multiple service providers from any number of partnering websites utilizing an online format, a database of service providers, and a automated multiple e-mail contact system which will then allow those service providers to respond according to their ability to meet the desires of the customer.

### OBJECTS AND ADVANTAGES

Accordingly, besides the objects and advantages of the immediate multiple contact from different points of access on the Internet described in my above patent, several objects and advantages of the present invention are:

(a) to provide a means for service providers contained in our database to gain exposure on numerous websites while working with only one company;

(b) to provide a means for time and cost savings to website visitors in contacting numerous service providers;

(c) to provide a means for additional marketing exposure to partnering website companies through additional value-added content search capabilities being located on their websites;

(d) to provide a means for a contact system that will not require any party to fulfill a contract with the other, but will serve only as a means of obtaining information and facilitating further communication between the parties.

### DRAWING FIGURES

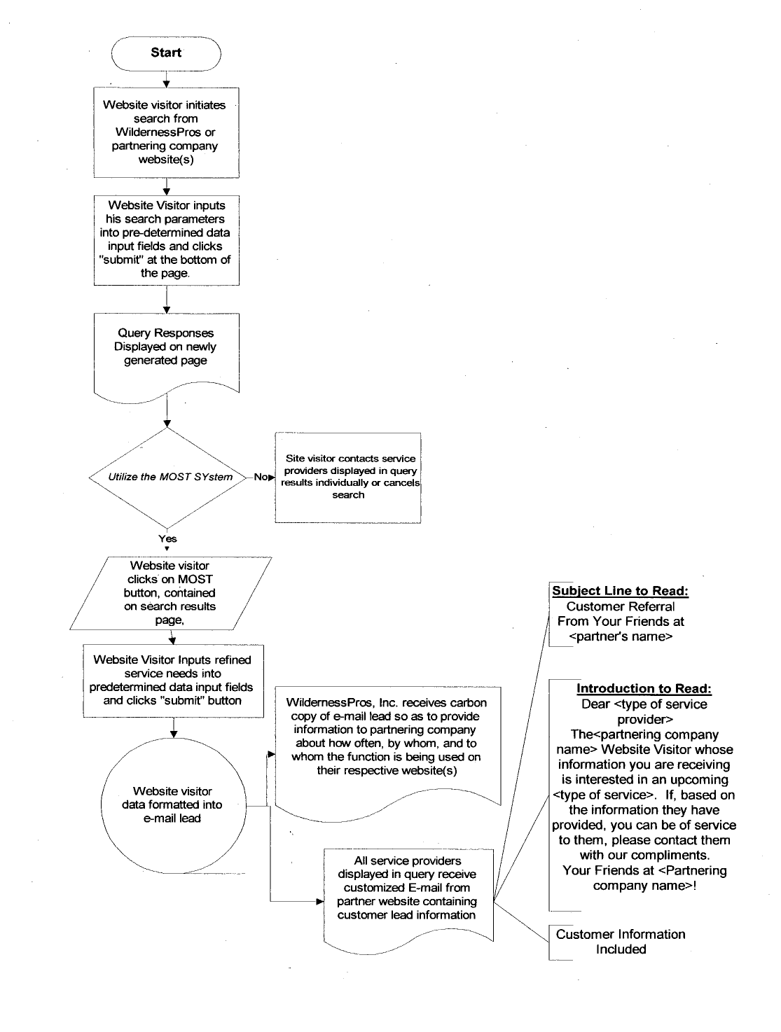

In the drawings, a flowchart (FIG. 1-A) has been used to demonstrate the means by which our business model functions within the framework of partnering company websites. The flowchart demonstrates a means whereby a website visitor can, from any partnering website utilize the MOST system in conducting a search and contacting, en masse, service providers who meet the criteria the said website visitor has input into the predetermined data input fields provided by the MOST system.

### DESCRIPTION—PREFERRED EMBODIMENT

The M.O.S.T. system is part of a larger Internet-based search engine; an online system for finding and providing information on outdoor recreation service providers based on a comprehensive and flexible database. The search engine, MOST functionality, and all other dynamic content provided by the system is coded as PHP scripts residing on an Internet web server utilizing MySQL as its database engine. The system can be installed on any web server-referred to in this document as the “owner” server-that supports PHP, MySQL and e-mail sending capabilities. (via PHP configuration and function calls). No platform specific requirements exist.

The MOST system can be shared via the Internet, and its services can be implemented through any number of “partner” servers. The MySQL data, PHP code, and any required static or dynamic HTML pages reside on the “owner” server, while partnering companies establish a connection to this system through their own servers. This connection can be as simple as providing the search/MOST queries by means of an owner-hosted web page embedded in a partner-hosted HTML frameset, or it can be as sophisticated as a secured XML-encoded query and response between two servers, with the owner server providing the data and the partner server formatting and generating dynamic web pages.

Any form of connection will include the submission of a “partner ID” that is used by the PHP scripts to customize query scopes and other data, to produce custom formatting to create a seamless, integrated appearance within the partner's web pages, and to include custom branding or advertising messages within MOST-generated documents.

When a partner server initiates a new search on behalf of an “end user,” it provides two values to the search/MOST system. The first is a “search-type” value, specifying the service being searched, and is used to configure and provide the necessary search parameters by, for example, XML or by a dynamically generated HTML form. The second value provided is the aforementioned “partner-ID” value, for specifying the referring partner company website. A standard online search is conducted against the MySQL database, and a list of all matching service providers is returned, once again by means of standard channels such as XML or a new HTML page generated by the search/MOST system. This returned dataset can then be used to activate the MOST system.

This dataset provides one record for each matching service provider, containing its unique “service provider ID” within the search/MOST system, along with other key information for that service provider (name, matched search terms, links to additional information about the service provider as contained within the search/MOST system). If the dataset is returned by the owner server as an HTML page, the HTML page is partner-specifically formatted and contains an embedded HTML form. When the form is “submitted” by a special MOST activation button back to the owner server, a new HTML format and page is generated to collect additional information required by the MOST system. If a different data transfer method is used, such as XML, then the dataset is passed back to the owner system along with the additional information required by the MOST system. This additional information that the MOST system requires includes specific requirements, details, and contact information on behalf of the “end user.”

Once this information is collected from the end user and validated, the final section of the MOST system generates notifications, most commonly in the form of e-mails. One response goes to each of the service providers that were returned in the initial query. These responses include the specific information provided by the “end user” about his service requirements, his contact information, and, if the response is in the form of an e-mail, each service provider's e-mail address is placed in the response's “blind carbon copy” (BCC) header, while the “From” field indicates the “end user's” name and e-mail address. If the referring partner company has activated and provided a special advertising/branding message, then this message is included in the response to the service providers. The response is always “branded” with the integration of the partner company's name into any subject headers and within the body of the response. An additional copy of each response is also sent to the owner server in the form of an e-mail filed into a pre-determined e-mail box that included not only the information that was sent to the service providers, but also the identities of which service providers were contacted. This function allows for the tracking of usage of the MOST system from the partner company websites.

A response can also be automatically sent to the “end user” on behalf of the partner company. This can include any desired and approved advertising/branding message. This is an option that a partner company can activate or deactivate on its behalf at any time through a secured “partner administration” section. Once the responses are sent to the service providers, the “end user” (optional), and the owner company, the “end user” will receive a “Thank You” message through their web browser to let him know that his request was successfully processed.

### ADVANTAGES

From the description above, a number of advantages of our MOST system become evident:

(a) An “end user” can contact multiple service providers with one simple Internet based form rather than making numerous long distance phone calls or replication of numerous e-mail inquiries.

(b) With the ability to seamlessly integrate the MOST system into partner company websites, there is an additional search function added to their websites which provides a “value-added” service to their website visitors.

(c) The ability of the service providers to be located on one search system that is being placed on high-traffic partnering company websites gives them an increased marketing presence.

(d) Responses from the MOST system to service providers that are being branded from partnering companies provides those companies with a unique method of branding to a specific target population of service providers.

(e) The response copy feature whereby each response that is sent out to the service providers in any given search is provided to the owner company with the names of the service providers included gives quantifiable data from which to determine the effectiveness of the MOST system for the partnering companies and service providers alike.

### CONCLUSION, RAMIFICATIONS, AND SCOPE

Accordingly, the reader will see that the MOST system can be used by “end users” and partnering companies for a number of search and contact functions while providing unique branding opportunities. Furthermore, the MOST system has the additional advantages in that

It permits a company to have a specific, targeted service provider search on its website that will coincide with its particular area of business

It allows website visitors to search out and contact a specific, targeted group of service providers that are of interest to them (by virtue of the fact that they are on the partnering company's website) in a time and cost saving manner.

It provides a broad advertising/branding opportunity to the service providers housed in the database by placing them in a search and contact system that is seamlessly integrated into high-profile partnering company websites that are within the same field of business as the service providers.

It provides the ability to quantify the success for both the partnering company and service providers through response generation and tracking e-mail information provided to owner companies.

Although the description above contains many specifics, these should not be construed as limiting the scope of the presently preferred embodiments of this invention, but merely providing illustrations of some of the presently preferred embodiments of this invention. For example, the MOST system can be used with additional types of service providers such as golf course operators, lodging companies, tourism specialists, and residential and commercial contractors.

Thus the scope of the invention should be determined by the appended claims and their legal equivalents, rather than by the examples given.

I claim:

1. A means whereby a website visitor can search for and contact multiple service providers from a plurality of predetermined partnering company websites comprising
(a) Providing an online form that has been formatted to the color and look of said partnering company website for said website visitor to complete, said form having a predetermined number of data input fields in which said website visitor must indicated a plurality of service desires.
(b) Providing an online search results form on said partnering company website for said website visitor to view, said search results form will contain a plurality of said service providers whose service offerings match with said website visitor's said service desires.
(c) Providing said website visitor with an online multiple contact form on said partnering company website, said multiple contact form will contain a plurality of predetermined data input fields, said data input fields are used to further refine said website visitor's said service desires.
(d) Providing said website visitor with an online means whereby said website visitor can transmit said online multiple contact form to the plurality of said service providers whose service offerings match said website visitor's said service desires. Said online multiple contact form provides specific e-mail business leads to service providers enabling said service providers to submit responses for services to said website visitor.

2. The means of claim 1 wherein said partnering company website has the option to limit said website visitor's access to defined portions of the searchable database of said service providers

3. The means of claim 1 wherein said partnering company website can access the online multiple contact form to send messages from said partnering company regarding any potential advertising or branding message they might choose to be received by said service providers or said website visitor.

4. The means of claim 1 wherein said partnering company website can send an auto-response message in e-mail format to said website visitor upon submitting his said service desires to said service providers using said online multiple contact form. Said auto-response message may be of any nature the partnering-company desires for advertising, brand awareness purposes and further marketing.
